(19) United States
(12) Patent Application Publication
(10) Pub. No.: US 2010/0060234 A1
(43) Pub. Date: Mar. 11, 2010

(54) Charging/Powering Device for an Electronic Device and Electronic Device Incorporating Same

(76) Inventor: Sabatino Nacson, Thornhill (CA)

Correspondence Address: BAKER & DANIELS LLP;111 E. WAYNE STREET, SUITE 800, FORT WAYNE, IN, 46802, US

(21) Appl. No.: 12/401,474

(22) Filed: Mar. 10, 2009

Related U.S. Application Data
(60) Provisional application No. 61/064,503, filed on Mar. 10, 2008.

(51) Int. Cl. H02J 7/00; H02K 11/00; H02K 7/10

(52) U.S. Cl. 320/114; 320/107; 310/66; 310/75 R

(57) ABSTRACT

A charging/powering device comprises at least one manually rotatable element, a power generating mechanism coupled to the at least one rotatable element, the power generating mechanism converting rotational movement of said at least one rotatable element into electrical energy and an energy harvesting module collecting and storing the electrical energy generated by the power generating mechanism, the energy harvesting module further being operable to output stored electrical energy.

### CROSS-REFERENCE TO RELATED APPLICATIONS

This application claims the benefit of U.S. Provisional Application Ser. No. 61/064,503 filed on Mar. 10, 2008 for an invention entitled “Self-Powered Computer-Pointing Device”.

### FIELD OF THE INVENTION

The present invention relates generally to electronic devices and more specifically, to a charging/powering device for an electronic device and to an electronic device incorporating same.

### BACKGROUND OF THE INVENTION

Computer-pointing devices are often used in connection with computers to facilitate user interaction with application programs and to enhance the functionality of the computers. One common type of computer-pointing device is the cord-based mouse. This type of mouse is connected to the computer by a cord and is moved over a pad or other suitable surface to effect movement of the cursor displayed on the monitor of the computer. When the cursor is positioned at the desired location, actions can be invoked by clicking on one of the mouse buttons and/or rotating the mouse scroll wheel(s). Using the mouse in this manner allows a computer user to navigate through graphical user interfaces displayed on the computer monitor quickly and easily thereby facilitating user interaction with various files and application programs.

Although this type of mouse is satisfactory for the most part, problems do exist. Since the mouse is physically connected to the computer by the cord, the cord restricts the movement capabilities of the mouse. If the cord is taut, the user is required to lift the mouse off the pad to provide slack in the cord before placing the mouse back down on the pad. Also, the user is required to navigate the mouse in close proximity to the computer.

More recently, developments in the field of mouse technology have led to the cordless mouse. As will be appreciated, the cordless mouse overcomes the problems associated with the cord-based mouse discussed above. However, the cordless mouse suffers from its own disadvantage. Since the cordless mouse is not physically connected to the computer, the cordless mouse is not able to draw power from the computer power supply. Therefore, the cordless mouse requires batteries to provide the power necessary to function. Batteries of course require replacing when they run low and as will be appreciated, replacing batteries is inconvenient. Also, batteries can drain at unexpected and inappropriate times creating user annoyance, especially if the batteries drain while the user is in the middle of an important project.

To deal with this power supply problem, a number of self-powered auxiliary input devices have been considered. For example, U.S. Pat. No. 5,838,138 to Henty discloses a system having a mechanical power convertor to convert mechanical energy applied to the keys of a keyboard into electrical energy that is used to charge a rechargeable battery. The power convertor includes a thin high strength magnet that is fixed to the central portion of each key. A coil surrounds each magnet. Each coil is mounted on a mandrel that is attached to the keyboard. Current is induced in a coil when its associated key is actuated.

U.K. Patent Application No. 2,314,470 to Tien discloses a mouse accommodating a rechargeable battery that is re-charged by a magnetic field generated by primary and secondary induction coils of a charging device. The secondary induction coil is displaced from the primary induction coil. The battery is connected to the secondary induction coil and is charged when the induction coils are located adjacent one another such that a current in the primary induction coil induces a current in the secondary induction coil.

Japanese Patent Application No. 10283079 to Sony Corporation discloses a mouse with a detection roller that moves in two axial directions corresponding to the rotation of a roller ball. A roller rotation detector senses the amount of movement of the detection roller in the two axial directions. A transmission circuit communicates with the roller rotation detector and converts the sensed movement of the detection roller into electromagnetic signals. Electric power is produced by a generator in response to the electromagnetic signals. The produced electric power is stored by a secondary battery and supplied to the transmission circuit.

U.S. Pat. No. 6,903,725 to Nacson discloses a self-powered computer-pointing device comprising a housing and a roller ball accommodated within the housing. At least a portion of the roller ball is exposed through an opening in the housing to allow the roller ball to contact a surface on which the computer-pointing device rests. Movement of the computer-pointing device across the surface imparts rotation of the roller ball. A sensing mechanism senses movement of the roller ball and generates x-y movement signals corresponding to movement of the computer-pointing device across the surface. The sensing mechanism conveys the x-y movement signals to a host computer. A power generating mechanism is coupled to the roller ball and converts rotational movement of the roller ball into electrical energy that is used as power by the computer-pointing device.

The disadvantages associated with the cordless mouse discussed above are of course not limited to cordless mice. Other electronic devices such as for example cellular telephones, personal digital assistants (PDAs), BlackBerrys®, hand-held gaming units etc. draw power from batteries that may drain at unexpected and inappropriate times. As will be appreciated, improvements in the charging/powering of electronic devices are desired.

It is therefore an object of the present invention to provide a novel charging/powering device for an electronic device and a novel electronic device incorporating the same.

### SUMMARY OF THE INVENTION

The present invention provides a charging/powering device that converts movement of a rotatable element into electrical power that is used either to power directly an electronic device, to charge an external power supply or to charge an internal power store.

Accordingly, in one aspect there is provided a charging/powering device comprises at least one manually rotatable element, a power generating mechanism coupled to the at least one rotatable element, the power generating mechanism converting rotational movement of the at least one rotatable element into electrical energy and an energy harvesting module collecting and storing the electrical energy generated by the power generating mechanism, the energy harvesting module further being operable to output stored electrical energy.

In one embodiment, the power generating mechanism comprises a generator coupled to the at least one rotatable element by a gear train. A gear box acts between the gear train and the generator. The at least one rotatable element is a scroll wheel. A voltage regulator regulates the output of the energy harvesting module.

In one form, the at least one rotatable element, power generating mechanism and energy harvesting module are accommodated within a housing. The housing has an opening through which at least a portion of the at least one rotatable element extends. A jack is provided on the housing to accept a cable extending to an external electronic device. In another form, the charging/powering device is incorporated into an electronic device. The electronic device may be for example one of a cellular telephone, personal digital assistant, BlackBerry® and hand-held gaming unit.

According to another aspect there is provided a self-powered computer-pointing device comprising a housing, at least one rotatable element protruding from the housing and being manipulatable by a user, a sensing mechanism sensing movement of the mouse and generating x-y movement signals corresponding to movement of the computer-pointing device, the sensing mechanism conveying the x-y movement signals to a host computer, and a power generating mechanism coupled to the at least one rotatable element, the power generating mechanism converting rotational movement of the at least one rotatable element into electrical energy that is used as power by the computer-pointing device.

In one embodiment, the power generating mechanism is directly coupled to the at least one rotatable element and comprises a generator that generates electrical energy in response to rotation of the at least one rotatable element. In one form, the generator is coupled to the at least one rotatable element via a gear train. In another form, the generator is coupled directly to the at least one rotatable element. The at least one rotatable element in one form is a scroll wheel.

The present invention provides advantages in that since the charging/powering device is of a simple design, it can to be manufactured inexpensively and is less prone to mechanical failure. The design of the charging/powering device also allows it to be incorporated into electronic devices inexpensively. When the charging/powering device is incorporated into an electronic device such as for example a computer-pointing device, cellular telephone, PDA, BlackBerry®, hand-held gaming unit etc., the electronic device has an extended operating time as compared to conventional electronic devices due to the fact that movement of the rotatable element(s) of the electronic device is converted into electrical power. This enables the electronic device to be continually powered through rotation of the rotatable element(s).

### BRIEF DESCRIPTION OF THE DRAWINGS

Embodiments will now be described more fully with reference to the accompanying drawings in which:

FIG. 1 is a perspective view of a cordless computer-pointing device;

FIG. 2 is a schematic block diagram of the cordless computer-pointer device of FIG. 1;

FIG. 3 is a schematic block diagram of a power generating mechanism forming part of the cordless computer-pointing device of FIG. 1;

FIG. 4 is a schematic block diagram of another power generating mechanism;

FIG. 5 is a schematic block diagram of yet another power generating mechanism;

FIG. 6 is a bottom plan view of an alternative cordless computer-pointing device;

FIG. 7 is a front elevational view of a charging/powering device for an electronic device with its cover removed to expose the internal components thereof;

FIG. 8 is a perspective view of the charging/powering device of FIG. 7;

FIG. 9 is a block diagram of internal components of the charging/powering device of FIG. 7;

FIG. 10 is a block diagram showing the charging/powering device of FIG. 7 connected to an electronic device via a physical cable; and

FIG. 11 is a block diagram showing the charging/powering device of FIG. 7 integrated into an electronic device.

### DETAILED DESCRIPTION OF THE PREFERRED EMBODIMENTS

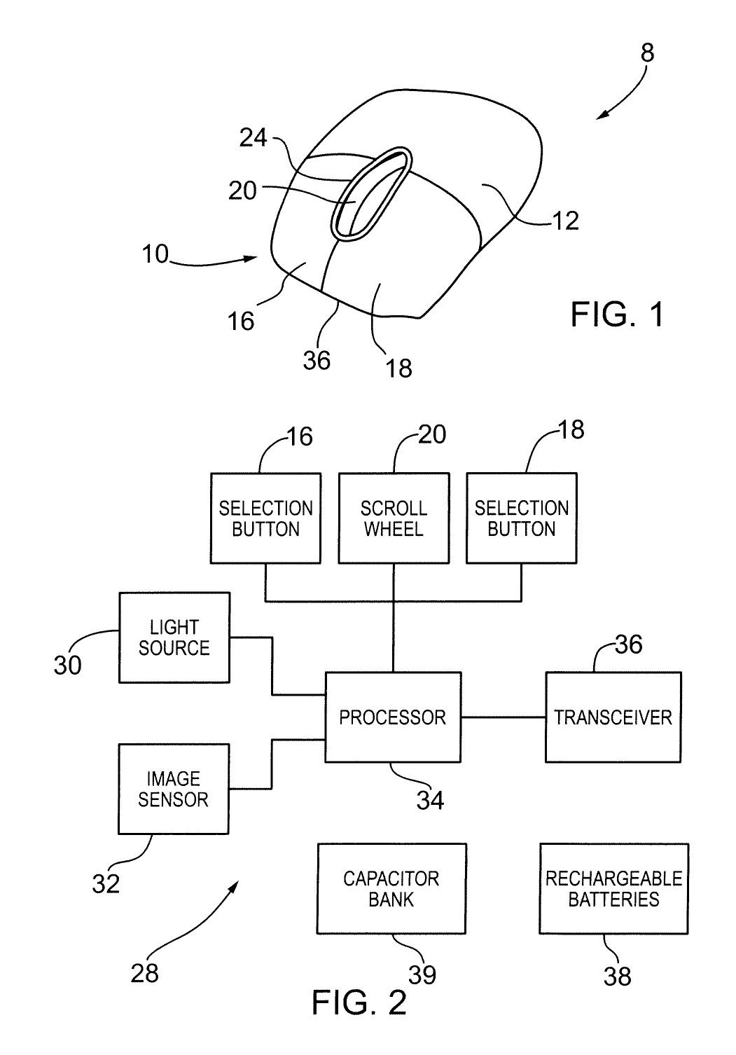

Turning now to FIG. 1, a computer-pointing device in the form of a cordless mouse is shown and is generally identified by reference numeral 8. The cordless mouse 8 includes a generally ovate, smoothly contoured housing 10. A pair of buttons 16 and 18 is provided on the upper surface 12 of the housing 10 near its front end. A scroll wheel 20 protrudes through an opening in the upper surface 12 of the housing 10. In this embodiment, the scroll wheel 20 is positioned between the two buttons 16 and 18 within a well 24 formed in the upper surface 12. The housing 10 is ergonomically shaped so that the hand of a user may fit comfortably around the mouse 8 while allowing the user to interact with the buttons 16 and 18 and the scroll wheel 20.

The mouse 8 in this embodiment is an optical mouse and accordingly, the interior of the housing 10 accommodates a circuit board on which the optoelectronics of the mouse 8 are mounted. As is well known and shown in FIG. 2, the optoelectronics 28 comprise a light source 30 such as for example, a laser or light emitting diode (LED) to illuminate a portion of the surface across which the mouse 8 is moved and an image sensor 32 to capture image frames of the illuminated surface. A processor 34 executing a movement detection application processes each pair of successive image frames captured by the image sensor 32 to determine relative motion between the successive image frames and hence, movement of the mouse 8 and translates the relative motion into x-y movement signals. The processor 34 also monitors the selection buttons 16 and 18 and generates selection button depression signals in response to presses of the selection buttons. The processor 34 further monitors the scroll wheel 20 and generates scroll wheel movement signals in response to rotation of the scroll wheel 20. The x-y movement signals, selection button depression signals and/or scroll wheel movement signals are output by the processor 34 to an infrared transceiver 36, which in turn broadcasts the signals to a host computer (not shown) via a wireless communications link. The optoelectronics 28 are powered by rechargeable batteries 38. The rechargeable batteries 38 are recharged by a capacitor bank 39. If desired, the power stored by the capacitor bank 39 can be used to power the mouse 8 directly.

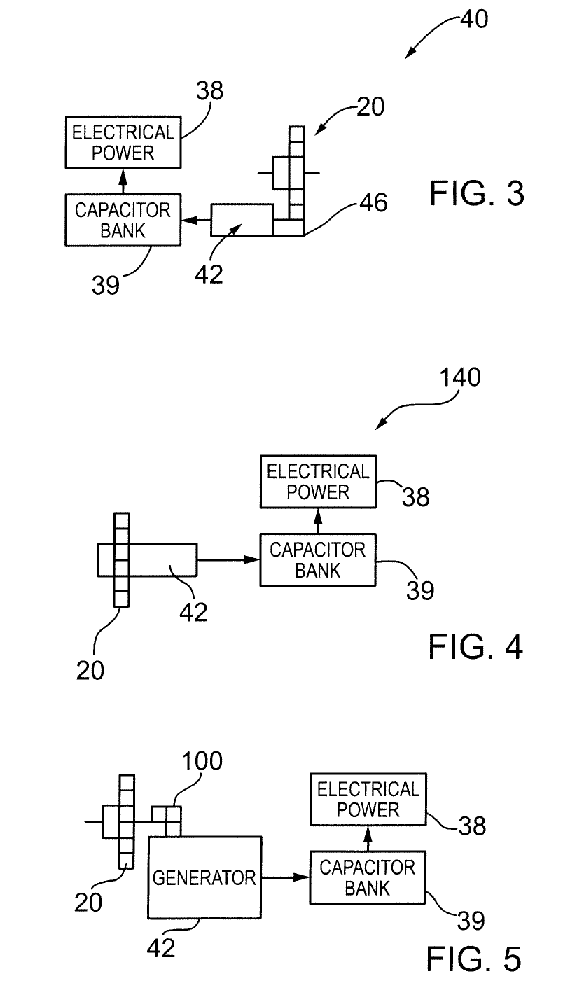

A power generating mechanism 40 to convert rotation of the scroll wheel 20 into electrical power is also mounted on the circuit board within the housing 10 as shown in FIG. 3. The power generating mechanism 40 comprises a twelve (12) volt direct current (DC) generator 42 having a driven shaft that is rotatably coupled to the scroll wheel 20 via a gear train 46 having a 10:1 ratio. In this manner, one (1) revolution of the scroll wheel 20 results in the driven shaft of the generator 42 being rotated through ten (10) revolutions. The electrical output of the generator 42 is fed to the capacitor bank 39 for storage allowing the capacitor bank 39 to recharge the rechargeable batteries 38. The operation of the power generating mechanism 40 will now be described.

When the scroll wheel 20 is rotated, the gear train 46 imparts rotation of the driven shaft of the generator 42. Rotation of the driven shaft of the generator 42 results in the generator generating electrical output that is fed to the capacitor bank 39. The electrical output of the generator 42 for a scroll wheel rotation of less than one-hundred (100) rotations per minute (rpms) will typically be in the range of from about 100 to 300 mV at a current of 100 mA. Thus, a ten (10) second rotation of the scroll wheel 20 will result in approximately 0.3 joules of electrical energy being fed to the capacitor bank 39. As will be appreciated, the power generating mechanism 40 is of a simple design yet allows movement of the scroll wheel 20 to be converted into electrical energy that is used to power the mouse 8.

Turning now to FIG. 4, another embodiment of the power generating mechanism 140 is shown. In this embodiment, the driven shaft of the generator 42 is in line with and directly coupled to the shaft of the scroll wheel 20. As a result, the scroll wheel 20 and the generator 42 have a 1:1 ratio. Alternatively, as shown in FIG. 5, the generator 42 may be oriented so that the driven shaft of the generator forms a 90 degree angle with the shaft of the scroll wheel 20. A 90 degree gear box 100 couples the driven shaft of the generator 42 and the shaft of the scroll wheel 20 in a 10:1 ratio.

Although the mouse 8 is shown as comprising two (2) selection buttons 16 and 18 and a single scroll wheel 20, those of skill in the art will appreciate that this is for illustrative purposes only. The mouse 8 may of course comprise more than two selection buttons or may comprise a single selection button. The mouse 8 may also comprise more than one scroll wheel. In this case, a power generating mechanism may be provided for each or for multiple scroll wheels.

In the above-embodiments, the mouse 8 is shown and described as being an optical mouse. Those of skill in the art will appreciate that the mouse may be of the roller-type and comprise a roller ball protruding from the undersurface of the housing. In this case, the power generating mechanism may be used in conjunction with a power generating mechanism coupled to the roller ball such as that shown in aforementioned U.S. Pat. No. 6,903,725 to Nacson, the content of which is incorporated herein by reference. Although the above power generating mechanisms are described as being used in a cordless computer-pointing device, those of skill in the art will appreciate that the power generating mechanisms can also be used in a cord-based computer-pointing device that requires additional power to enable enhanced functionality.

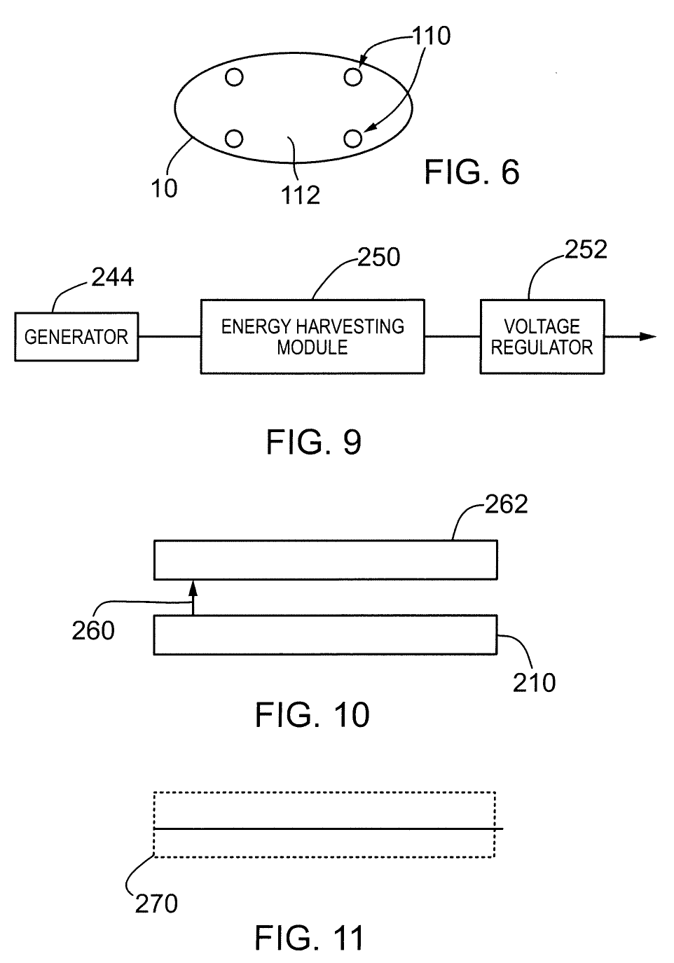

FIG. 6 shows yet another embodiment of a cordless mouse. In this embodiment, a plurality of rotatable roller balls 110 formed of polypropylene (plastic) and acting as feet protrudes through the undersurface 112 of the housing 10. The driven shaft of a miniature generator similar to one of those described above is coupled to each roller ball 110 via an intermediate roller (not shown). During use of the mouse, movement of the mouse along a surface causes the roller balls 110 to rotate which in turn imparts rotation of the driven shafts of the generators via the intermediate rollers. As the driven shafts of the generators rotate, the generators provide electrical output that is fed to the capacitor bank 39 for storage. As will be appreciated, the miniature generators, intermediate rollers and roller balls may be used to compliment or to replace the power generating mechanism coupled to the scroll wheel 20.

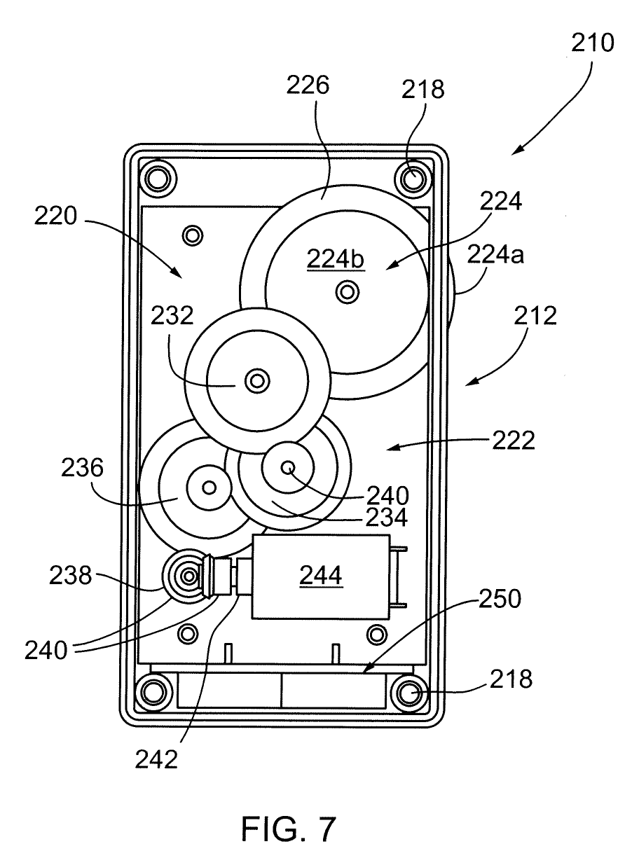

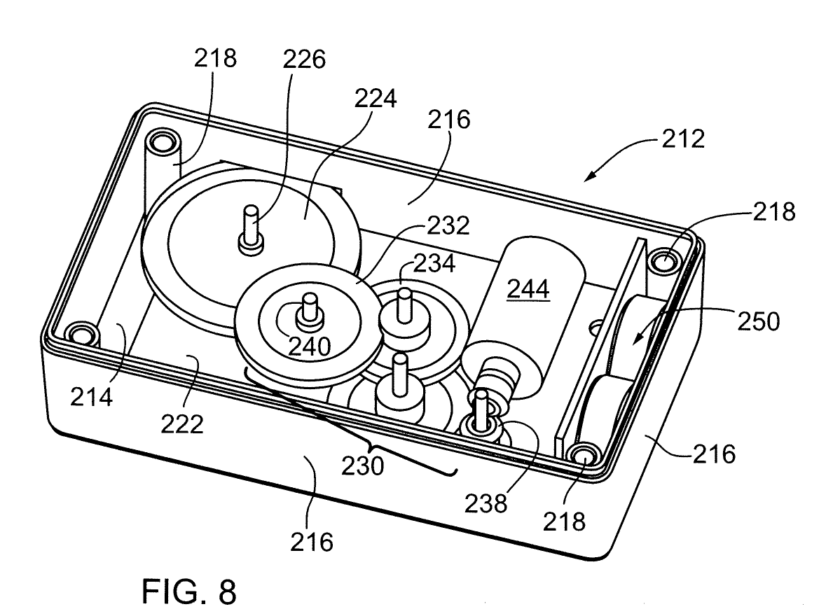

Turning now to FIGS. 7 to 9, a charging/powering device for an electronic device such as for example, a cellular telephone, PDA, BlackBerry®, hand-held gaming unit etc. is shown and is generally identified by reference numeral 210. Charging/powering unit 210 comprises a rectangular, box-shaped housing 212 having a base 214 and upstanding side walls 216 about the periphery of the base. Upstanding threaded posts 218 are provided adjacent the corners of the base 214. A cover plate (not shown) is releasably secured to the housing 212 by fasteners (not shown) that pass through holes in the cover plate and engage the threaded posts 218 thereby to enclose the internal components of the charging/powering device 210.

A power generating mechanism 220 to convert rotational energy into electrical power is mounted on a mounting plate 222 that is secured to the base 214 of the housing 212. Power generating mechanism 220 comprises a scroll wheel 224 mounted on a shaft 226 that extends upwardly from the mounting plate 222. A portion 224a of the periphery of the scroll wheel 224 extends through an elongate opening in one of the side walls 216 to permit a user to rotate the scroll wheel 224 manually from outside of the housing 212 using a thumb or finger. The top surface 224b of the scroll wheel 224 adjacent its periphery carries teeth 226 that engage a gear train 230 comprising four intermeshing gears 232 to 238. Each of the gears 232 to 238 is similarly mounted on a shaft 240 that extends upwardly from the mounting plate 222. The gear train 230 in this embodiment has a ratio of 1:10 so that one (1) rotation of the scroll wheel 224 results in ten (10) rotations of the gear 238.

Gear 238 engages a bevel gear 240 that is mounted on a shaft 242 extending from a high efficiency generator 244 having an associated gear box (not shown). In this embodiment, the gear box has a ratio of 1:40 so that one (1) rotation of the gear 238 results in forty (40) rotations of the generator drive shaft. The generator 244 in this embodiment is selected so that its peak output voltage is approximately 15 VDC.

The generator 244 communicates with an energy harvesting module 250. In this embodiment, the energy harvesting module 250 is of the type manufactured by Advanced Linear Devices, Inc. of Sunnyvale, Calif., U.S.A. under Model No. 585-EH301A. As is known, the energy harvesting module 250 collects the electrical energy output of the generator 244 and stores the electrical energy allowing the stored electrical energy to be used to charge or power an external electronic device. Electric double-layer capacitors commonly referred to as supercapacitors or ultracapacitors are employed to store the electrical energy output by the generator 244. A voltage regulator 252 acts between the energy harvesting module 250 and an output jacket (not shown) provided on the housing 212 to maintain the output voltage of the charging/powering device 210 at a level suitable for the electronic device to be charged or powered. In this embodiment, the voltage regulator maintains the output voltage of the charging/powering device generally at 5 VDC as this voltage level is suitable to charge 3.7V Lithium batteries used to power many hand-held electronic devices. The jack accepts a cable 260 that interconnects the charging/powering device 210 to the electronic device 262 as shown in FIG. 10 thereby to allow energy stored by the energy harvesting module 250 to be used to charge/power the electronic device.

In operation, when the scroll wheel 224 is rotated, the scroll wheel imparts rotation of the gears 232 to 238 of the gear train 230. The gear train 230 in turn imparts rotation of the shaft 242 via the bevel gear 240 resulting in the generator 244 generating electrical output that is collected by the energy harvesting circuitry 250 and stored by the supercapacitors. When the charging/powering device 210 is connected to the electronic device 262 via the cable 260 as shown in FIG. 10 the energy stored by the energy harvesting module 250 can be used to charge the internal batteries of the electronic device or power the electronic device directly. Of course, the scroll wheel 224 can be manipulated when the charging/powering device 210 is connected to the electronic device 262 to maintain the energy stored by the supercapacitors as the supercapacitors provide energy to the electronic device.

Although the charging/powering device is shown as a separate unit in FIGS. 7 to 10, if desired, the charging/power device can be incorporated into an electronic device 270 such as a cellular telephone, PDA, BlackBerry®, hand-held gaming unit etc. as shown in FIG. 11 so that user manipulations of the scroll wheel 224 during use of the electronic device 270 also result in electrical power generation.

Although exemplary ratios for the gear train and generator gear box are disclosed, those of skill in the art will appreciate that the gear ratios can be varied. For example, in some environments a gear train ratio of 1:100 may be employed. The size of the generator used in the charging/powering device 210 is selected so that the peak output voltage of the generator is at a level suitable for the environment in which the charging/powering device is to be used.

The present invention provides a simple and inexpensive power generating mechanism for use with or in electronic devices that allows movement of one or more rotatable elements to be converted into electrical energy that can then be used to power the electronic devices.

Although embodiments have been described herein, those of skill in the art will appreciate that variations and modifications may be made without departing from the spirit and scope thereof as defined by the appended claims.

1. A charging/powering device comprising:
at least one manually rotatable element;
a power generating mechanism coupled to said at least one rotatable element, said power generating mechanism converting rotational movement of said at least one rotatable element into electrical energy; and
an energy harvesting module collecting and storing the electrical energy generated by said power generating mechanism, said energy harvesting module further being operable to output stored electrical energy.

2. A charging/powering device according to claim 1 wherein said power generating mechanism comprises a generator coupled to said at least one rotatable element.

3. A charging/powering device according to claim 2 wherein said generator is coupled to said at least one rotatable element by a gear train.

4. A charging/powering device according to claim 3 wherein said gear train has a ratio of at least 1:10.

5. A charging/powering device according to claim 1 wherein said at least one rotatable element is a scroll wheel.

6. A charging/powering device according to claim 1 further comprising a voltage regulator to regulate the output of said energy harvesting module.

7. A charging/powering device according to claim 2 further comprising a gear box acting between said gear train and said generator.

8. A charging/powering device according to claim 7 wherein said gear box has a ratio of 1:40.

9. A charging/powering device according to claim 1 wherein said at least one rotatable element, power generating mechanism and energy harvesting module are accommodated within a housing, said housing having an opening through which at least a portion of said at least one rotatable element extends.

10. A charging/powering device according to claim 9 further comprising a jack on said housing to accept a cable extending to an external electronic device.

11. A charging/powering device according to claim 10 wherein said power generating mechanism comprises a generator coupled to said at least one rotatable element.

12. A charging/powering device according to claim 11 wherein said generator is coupled to said at least one rotatable element by a gear train.

13. A charging/powering device according to claim 12 wherein said at least one rotatable element is a scroll wheel.

14. A charging/powering device according to claim 13 further comprising a voltage regulator to regulate the output of said energy harvesting module.

15. A charging/powering device according to claim 14 further comprising a gear box acting between said gear train and said generator.

16. A charging/powering device according to claim 1 incorporated into an electronic device.

17. A charging/powering device according to claim 16 wherein said electronic device is one of a cellular telephone, personal digital assistant, BlackBerry® and hand-held gaming unit.

18. A self-powered computer-pointing device comprising:
a housing;
at least one rotatable element protruding from said housing and being manipulatable by a user;
a sensing mechanism sensing movement of said mouse and generating x-y movement signals corresponding to movement of said computer-pointing device, said sensing mechanism conveying said x-y movement signals to a host computer; and
a power generating mechanism coupled to said at least one rotatable element, said power generating mechanism converting rotational movement of said at least one rotatable element into electrical energy that is used as power by said computer-pointing device.

19. A computer-pointing device according to claim 18 wherein said power generating mechanism is directly coupled to said at least one rotatable element.

20. A computer-pointing device according to claim 19 wherein said power generating mechanism comprises a generator indirectly coupled to said at least one rotatable element.

21. A computer-pointing device according to claim 20 wherein said generator is coupled to said at least one rotatable element via a gear train.

22. A computer-pointing device according to claim 19 wherein said power generating mechanism comprises a generator directly coupled to said at least one rotatable element.

23. A computer-pointing device according to claim 18 wherein said at least one rotatable element is a scroll wheel protruding through a surface of said housing.
